(19) United States
(12) Patent Application Publication
(10) Pub. No.: US 2002/0117844 A1
(43) Pub. Date: Aug. 29, 2002

(54) Vehicle frame with replaceable rearward inclined angles for front wheels

(76) Inventors: Kun-Chung Lin, Chia-I City (TW); Yung-Shuen Lin, Chia-I Hsien (TW)

Correspondence Address: BIRCH STEWART KOLASCH & BIRCH, PO BOX 747, FALLS CHURCH, VA, 22040-0747, US

(21) Appl. No.: 10/083,534

(22) Filed: Feb. 27, 2002

(30) Foreign Application Priority Data
Feb. 27, 2001 (TW) 90202871

(51) Int. Cl. B62D 21/00

(52) U.S. Cl. 280/781

(57) ABSTRACT

A vehicle frame with replaceable rearward inclined angles for front wheels allows users to alter the rearward inclining angle of the front wheels to form different car styles. The vehicle frame has a separable axle hub. The axle hub is a replaceable element which has apertures of different rearward inclined angles to selectively engage with the frame such that the front wheels may be inclined rearward at different angles to form different car styles.

### FIELD OF THE INVENTION

The invention generally relates to a vehicle frame with a replaceable rearward inclined angle for front wheels adopted for use on electric cars for children, and particularly relates to a vehicle frame that allows the front wheels to change the rearward inclined angle for forming different car styles.

### BACKGROUND OF THE INVENTION

There are numerous toys available on the market for children these days. Electric cars for children are quite popular because they offer children the feeling and excitements of driving cars.

Electric cars for children usually simulate the styles of real cars or motorcycles, such as police cars, beach cars, race cars, Harley motorcycles, etc. References can be found in U.S. Pat. Nos. D423,059, D417,245, D417,244 and D 423, 603.

FIG. 1 illustrates a conventional electric car for children adapted to the style of a motorcycle. A general electric car for children consists of many accessories. Structurewise, there is a frame, a seat, pedals, handgrips, fenders, and wheels. The power portion includes a motor, batteries and an accelerator. In terms of construction, an electric car for children that simulates a real motorcycle, depending on design styles, may include a frame, a seat, pedals, handgrips, fenders, etc. A given model has its unique structural accessories. To make cars of different styles or models, different sets of accessories have to be made. For designers and manufacturers, when there is a need to make minor changes of design styles, it is very helpful and can greatly reduce design and production costs if a portion of the accessories and parts can be used repeatedly.

For instance, in real motorcycles there is a style that allows the rider to sit thereon in a straddle manner. These straddle type motorcycles further can be grouped as general models, racing models and Hippie models. Besides having different looks, they also have different rearward inclined angles for the front fork of the front wheel. Compared with the general style, the front fork of the racing style is inclined rearward slightly while the hippie style is inclined rearward to a greater extent. Children cars adapted to those motorcycle styles usually have a directly forming front fork axle seat. Based on different inclined angles of different front forks, three different frames are designed to match different accessories to construct the general electric motorcycles, racing style electric motorcycles and hippie style electric motorcycles for children. As all of these are for seating a child in a straddle manner, except the front fork axle seats which have different rearward inclined angles, other portions of the frames are substantially the same. However, at present, manufacturers still have to design and fabricate three different types of frames to make those three different styles of child cars. As a result, production costs are difficult to reduce.

Moreover, children are often interested in new toys but get bored easily. A new electric car can pique a child's interests for only a short period of time. After the child's interest fades away, the car will not be used. Electric cars for children are quite expensive. They are generally priced between U.S.$250 and U.S.$350 for one set. Parents are unlikely to buy the same type of high priced toys repeatedly. It is a costly waste if a high priced toy such as an electric car is idle after being used for only a short period of time. To make the vehicle style changeable by altering or replacing accessories and parts so that the car can have various looks to maintain children's interest for a longer time period is a commendable design approach.

### SUMMARY OF THE INVENTION

In view of aforesaid disadvantages and concerns, the primary object of the invention is to provide an improved vehicle frame with a changeable rearward inclined angle for front wheels. Through a modular design, the vehicle frame may be altered to match different styles of cars, and the rearward inclined angle of the front fork may be changed by users to construct cars of different styles.

The vehicle frame according to the invention mainly includes a frame and an axle hub. The frame is for connecting various child car accessories to form a desired car for children. The frame has a front end with a fastening bore for engaging with the axle hub to pivotally couple with a front fork of the front wheels. The axle hub is a replaceable element. The axle hub has a coupling bore which may be designed and formed in different rearward inclined angles. Hence cars assembled with different axle hubs may have the front fork inclined rearward at different angles. As a result, different car styles can be formed.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a child car.

FIG. 2 is an exploded view of a first embodiment of the invention.

FIG. 3 is a perspective view of a first embodiment of the invention.

FIGS. 4A, 4B and 4C are schematic views of the axle hub for the first embodiment at various inclined angles.

FIGS. 5A and 5B are fragmentary schematic views of the structure of a second embodiment of the invention.

FIGS. 6A and 6B are fragmentary schematic views of the structure of a third embodiment of the invention.

FIGS. 7A and 7B are fragmentary schematic views of the structure of a third embodiment of the invention.

### DESCRIPTION OF THE PREFERRED EMBODIMENTS

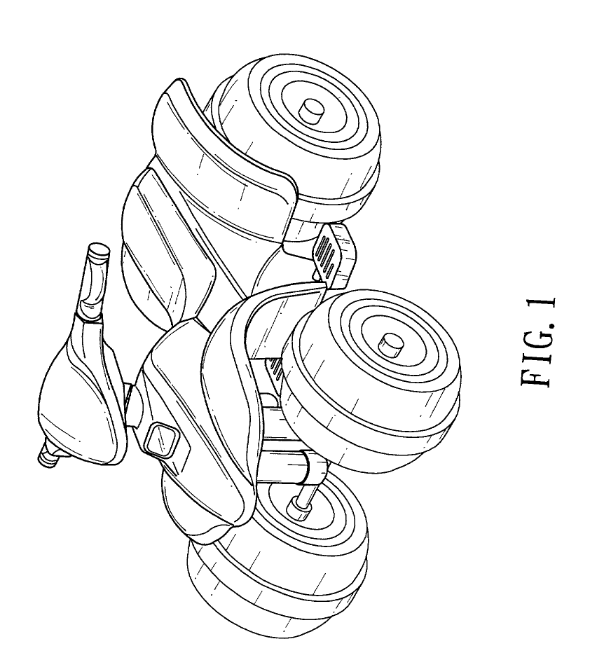

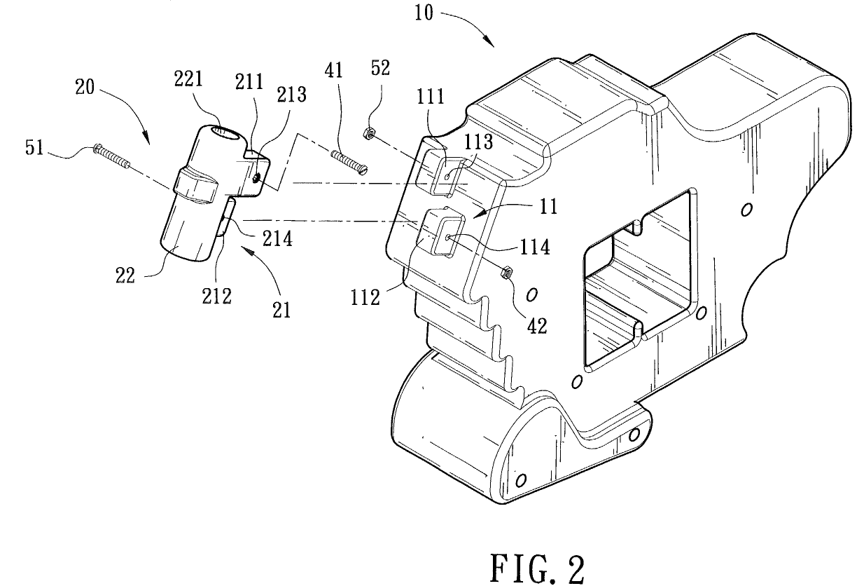

The invention aims to provide an improved vehicle frame with a replaceable rearward inclined angle for front wheels adopted for use on child cars. Electric cars for children generally consist of many accessories, mainly including a frame, a seat, pedals, handgrips, fenders, wheels, a motor, batteries, a transmission mechanism, and an accelerator (as shown in FIG. 1, with the interior portion omitted). These accessories and elements may be assembled to form various styles of automobiles or motorcycles. The seat is for a child to sit or ride. The batteries provide electric power for the motor. The motor outputs rotary power which is transmitted to the wheels through the transmission mechanism. The accelerator is used to control motor rotation for moving the car forward or backward. The frame 10 according to the invention is a modularized element. There is an axle hub 20 for pivotally coupling the front fork. The axle hub 20 may be separated from the frame 10 (as shown in FIG. 2) to achieve the object of the invention.

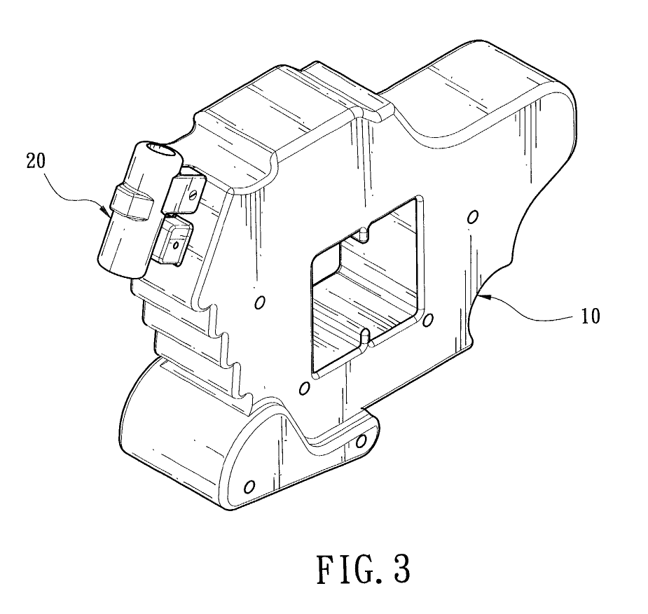

Referring to FIGS. 2 and 3, the improved vehicle frame of the invention includes a frame 10 and an axle hub 20. The frame 10 is for connecting various child car accessories to form a desired car for children (not shown in the drawings). The frame 10 has a connecting section 11 located on a front end thereof. The connecting section 11 has an upper connecting block 111 and a lower connecting block 112 located respectively on an upper and lower position, but not on the same straight line. The upper connecting block 111 has a first fastening bore 113 formed thereon, and the lower connecting block 112 has a second fastening bore 114 formed thereon. The fastening bores 113 and 114 may be plain and through holes or screw holes with internal screw threads.

The axle hub 20 may be fastened to the connecting section 11 of the frame 10, and includes a coupling section 21 and a pivotal connecting section 22. The coupling section 21 has an upper coupling block 211 corresponding to the upper connecting block 111 and a lower coupling block 212 corresponding to the lower connecting block 112. The coupling blocks 211 and 212 each have an aperture 213 and 214. The pivotal connecting section 22 has a through coupling bore 221 for housing the front fork 30 of the child car. The front fork 30 is turnable in the coupling bore 221. The front fork 30 has a bottom section to pivotally engage with the front wheels (not shown in the drawing), and a top end to couple with a handle bar to control the moving direction of the car (not shown in the drawings).

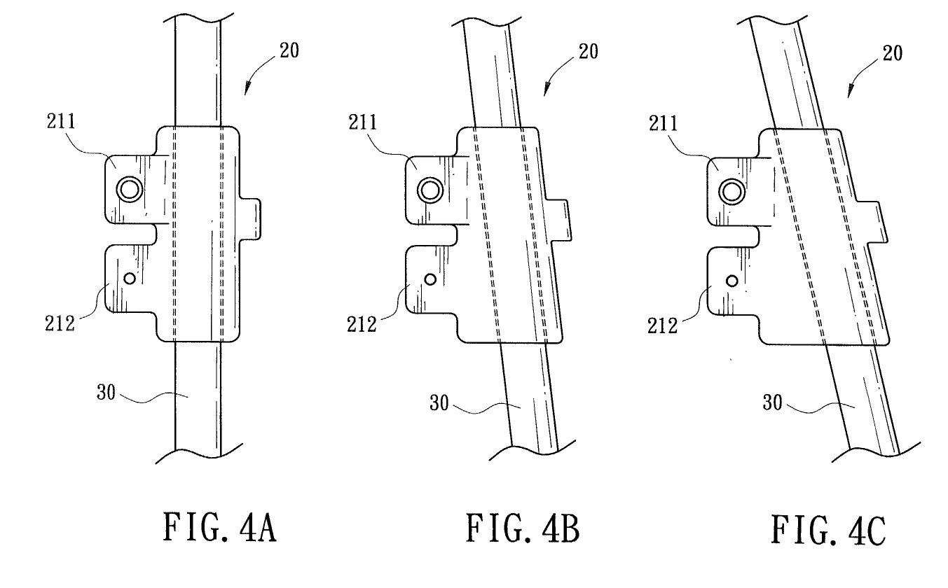

The axle hub 20 is engaged with the connecting section 11 of the frame 10 through the coupling section 21. The coupling blocks 211 and 212 and connecting blocks 111 and 112 are constructed in a staggered manner and are fastened together by means of screws 41 and 42 and screw nuts 51 and 52 running through the apertures 213 and 214 and fastening bores 113 and 114, thereby to anchor the axle hub 20 on the front end of the frame 10. As shown in FIGS. 4A through 4C, the axle hub 20 is a replaceable element. Hence different sets of axle hubs 20 may be designed with the coupling bores 221 formed at different rearward inclined angles. Thus axle hubs 20 with coupling bores 221 of various rearward inclined angles may be mounted to the front end of the frame 10 to tilt the coupling front fork 30 to different rearward inclined angles to suit the cars of different styles.

In the embodiment set forth above, the frame 10 is a modular element, and the axle hub 20 may be a replaceable element. In practice, the axle hub 20 may also be a modular element for directly adjusting the rearward inclined angle. The second, third and fourth embodiments depicted below adopt such as a design.

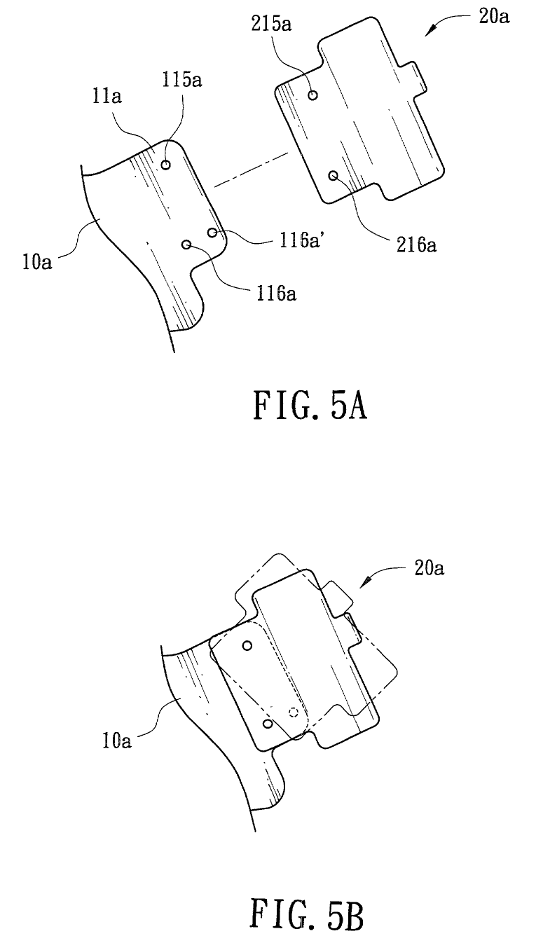

Referring to FIGS. 5A and 5B for a second embodiment of the invention, the connecting section 1 a of the frame 10a has three fastening bores 115a, 116a and 116a′. The first fastening bore 115a serves as a turning axis, and the second and third fastening bores 116a and 116a′ are used to adjust the rearward inclined angle. The axle hub 20a has a first aperture 215a corresponding to the first fastening bore 115a, and a second aperture 216a corresponding to the second and third fastening bores 116a and 116a′. By means of screws and screw nuts, the first aperture 215a and the first fastening bore 115a may be coupled and fastened together, and the second aperture 216a and the second fastening bore 116a may be coupled and fastened together such that the axle hub 20a may be anchored to the front end of the frame 10a at a selected rearward inclined angle. When one wishes to change the rearward inclined angle of the axle hub 20a, s/he must unfasten the screws and screw nuts, and tilt the axle hub 20a until the second aperture 216a and the third fastening bore 116a′ are matched, then they may be coupled and fastened through the screws and screw nuts such that the axle hub 20a is mounted and tilted at another rearward inclined angle.

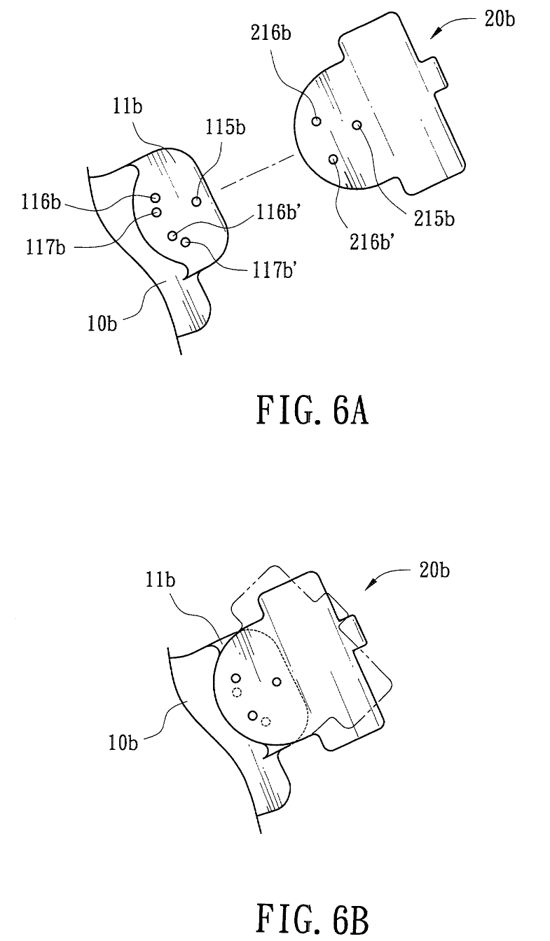

FIGS. 6A and 6B show a third embodiment of the invention. The connecting section 11b of the frame 10b has five fastening bores 115b, 116b, 116b′, 117b and 117b′. The first fastening bore 115b serves as a turning axis. The rest of the fastening bores 116b, 116b′, 117b and 117b′ are used for adjusting the rearward inclined angle. The axle hub 20b has apertures 215b, 216 and 216b′ corresponding to the fastening bores 115b, 116b, 116b′, 117b and 117b′. Similar to the second embodiment set forth above, the first fastening bore 115b and the first aperture 215b may be coupled and fastened through a screw and a screw nut (not shown in the drawings), while the aperture 216b may be coupled and fastened to the fastening bore 116b, and the aperture 216b′ may be coupled and fastened to the fastening bore 116b′. Thereby the axle hub 20a may be anchored to the front end of the frame 10b at a selected rearward inclined angle. Similar to the second embodiment, adjusting the rearward inclined angle may be done by coupling and fastening different sets of apertures and fastening bores.

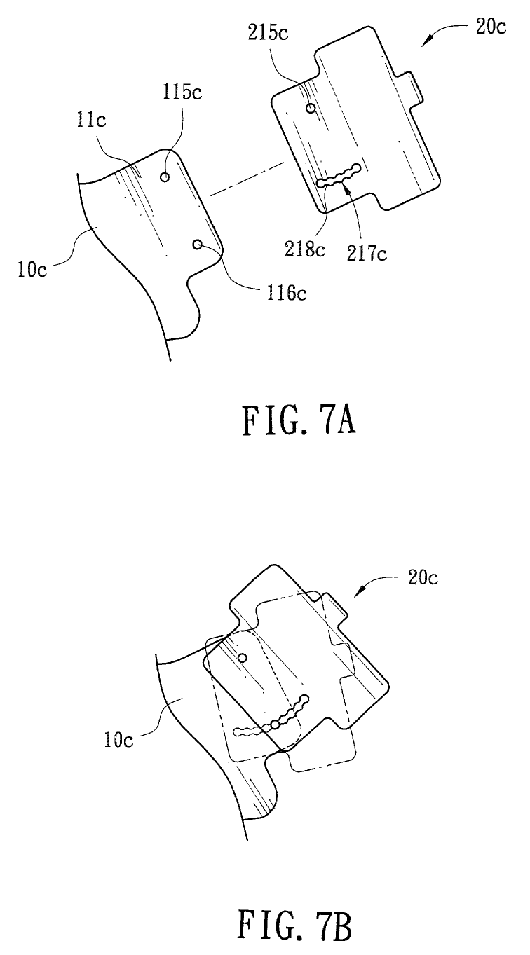

FIGS. 7A and 7B show a third embodiment of the invention. The connecting section 11c of the frame 10c has two fastening bores 115c and 116c. The axle hub 20c has an aperture 215c corresponding to the fastening bores 115c and 116c and an arched slot 217c, which has an axis coinciding with the aperture 215c. The arched slot 217c has a plurality of anchoring sections 218c. The first fastening bore 115c and the aperture 215c may be coupled and fastened together by means of a screw and a screw nut (not shown in the drawings). The second fastening bore 116c may be coupled with the arched slot 217c, and they are fastened together by means of a screw and a screw nut through a selected anchoring section 218c to anchor the axle hub 20c to the front end of the frame 10c at a selected rearward inclined angle. If the user unfastens the screw nut, the axle hub 20c may be moved and tilted to another rearward inclined angle, and the screw and screw nut may be coupled with another anchoring section 218c to make axle hub 20a incline to another angle.

In summary, by means of the modular design of the invention set forth above, the frame may be adopted to different car styles. Users can also change the rearward inclined angle of the front fork to transform the car frame for different car styles.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An improved vehicle frame with a replaceable rearward inclined angle for front wheels, comprising a frame for connecting accessories to construct a child car, characterized by:
said frame having at least one fastening bore on the front end to compose an axle hub inclined rearwards for a selected angle to form an axle seat for coupling with the front wheels.

2. The improved vehicle frame of claim 1, wherein the frame and the axle hub are fastened through a screw and a screw nut.

3. The improved vehicle frame of claim 1, wherein the axle hub has apertures formed thereon.

4. The improved vehicle frame of claim 3, wherein the fastening bore has internal screw threads to engage with a screw.

5. An improved vehicle frame with a replaceable rearward inclined angle for front wheels, comprising a frame for connecting accessories to construct a child car, characterized by:
said frame having a plurality of fastening bores on the front end to compose an axle hub inclined rearwards for a selected angle to form an axle seat for coupling with the front wheels;
wherein the axle hub is tilted to different rearward inclined angles through coupling and engaging the axle hub with the different fastening bores.

6. The improved vehicle frame of claim 5, wherein the frame and the axle hub are fastened through a plurality of screws and screw nuts.

7. The improved vehicle frame of claim 5, wherein the axle hub has apertures formed thereon, and number of the apertures being same as that of the fastening bores.

8. The improved vehicle frame of claim 5, wherein the fastening bores have internal screw threads to engage with screws after the screws running through the apertures.

9. The improved vehicle frame of claim 5, wherein the axle hub has apertures formed thereon, and number of the apertures being less than that of the fastening bores.

10. The improved vehicle frame of claim 9, wherein the fastening bores have internal screw threads to engage with screws after the screws running through the apertures.

11. The improved vehicle frame of claim 9, wherein the apertures are formed on selected locations to match selected fastening bores for engaging with screws to allow the axle hub fastening to the front end of the frame at a selected angle.

12. An improved vehicle frame with a replaceable rearward inclined angle for front wheels , comprising a frame for connecting accessories to construct a child car, characterized by:
said frame having a bore on the front end to compose an axle hub, said axle hub having an aperture and an arched slot to receive screws for engaging with the fastening bore to form an axle seat for coupling with the front wheels;
wherein the relative position between the axle hub and the frame is changeable through the arched slot for altering a rearward inclined angle of the axle hub.

13. The improved vehicle frame of claim 12, wherein the frame and the axle hub are fastened through a plurality of screws and screw nuts.

14. The improved vehicle frame of claim 12, wherein the fastening bores have internal screw threads.

15. The improved vehicle frame of claim 12, wherein the fastening bores has internal screw threads to engage with a screw after the screw running through the aperture and the arched slot.

16. The improved vehicle frame of claim 12, wherein the arched slot has a circle center which is coincided with the center of the aperture.

17. The improved vehicle frame of claim 12, wherein the arched slot has a plurality of anchoring sections.
